(19) United States
(12) Patent Application Publication
(10) Pub. No.: US 2016/0336591 A1
(43) Pub. Date: Nov. 17, 2016

(54) STRESS-BUFFERING SILICON-CONTAINING COMPOSITE PARTICLE FOR A BATTERY ANODE MATERIAL AND THE METHOD OF PREPARING THE SAME

(71) Applicants: James Ching-Hua LI, Taichung City (TW); GET GREEN ENERGY CORP., LTD, Taichung City (TW)

(72) Inventors: Kuo-Feng CHIU, Taichung City (TW); Po-Nien LAI, Taichung City (TW)

(21) Appl. No.: 15/111,397

(22) PCT Filed: Sep. 10, 2014
(86) PCT No.: PCT/US14/54929

§ 371 Date: Jul. 13, 2016

(30) Foreign Application Priority Data
Jan. 13, 2014 (TW) 103101137

(51) Int. Cl. H01M 4/36; H01M 4/134; H01M 4/62; H01M 4/38; H01M 4/587; H01M 10/0525; H01M 4/1395

(52) U.S. Cl. CPC H01M 4/366; H01M 10/0525; H01M 4/134; H01M 4/1395; H01M 4/386; H01M 4/587; H01M 4/622; H01M 4/625; H01M 2004/021

(57) ABSTRACT

A stress-buffering silicon-containing composite particle for a battery anode material, includes a stress-buffering particle having a Young's modulus greater than 100 GPa, a binder, and a silicon-containing shell surrounding and bonded to the stress-buffering particle through the binder. The silicon-containing shell has a plurality of silicon flakes that are randomly stacked and that are bonded to one another through the binder to form a porous structure.

### CROSS-REFERENCE TO RELATED APPLICATION

This application claims priority of Taiwanese Patent Application No. 103101137, filed on Jan. 13, 2014.

### FIELD OF THE INVENTION

This invention relates to a composite particle, more particularly to a composite particle for a battery anode material.

### BACKGROUND OF THE INVENTION

Lithium ion batteries are widely used in notebook computers, mobile phones, digital cameras, video cameras, personal digital assistants, Bluetooth headsets, and wireless 3C products. An anode of a conventional lithium ion battery mainly includes a carbonaceous material, such as mesocarbon microbeads (MCMBs, having a specific capacity of 310 mAh/g) and artificial graphite (having a specific capacity of 350 mAh/g). However, the full specific capacity of a carbon-based anode material has a theoretical value of 372 mAh/g, which cannot meet the requirement for high-power and high-energy density of future lithium ion batteries.

Compared to the carbon-based anode material or a graphite-based anode material, a silicon-containing anode material has a high theoretical specific capacity (3,800 mAh/g), approximately one order of magnitude higher than that of the graphite-based anode material (372 mAh/g). However, during charge and discharge of the lithium ion battery, the lithium ions undergo intercalation and de-intercalation on the silicon-containing anode material, which results in material expansion and contraction in the silicon-containing anode material. The conventional silicon-containing anode material includes silicon particles having a granular shape (i.e., non-flake-like particles) and a particle size in the order of several microns. The volume expansion of the conventional silicon-containing anode material may be up to 400% after being fully charged, which tends to cause cracking in the silicon-containing anode material and an increase in an internal impedance thereof, which, in turn, results in a decrease in the service life of the lithium ion battery.

Referring to FIG. 1, a conventional method of preparing a silicon-containing anode material 1 includes the steps of adding graphite particles 11 into a mixture solution of a solvent (not shown) and a binder 12, and then adding silicon particles 13 and a conductive carbon powder 14 into the mixture solution so as to mix and bind the graphite particles 11, the silicon particles 13 and the conductive carbon powder together through the binder 12 to form a silicon-containing anode material 1. However, as shown in FIG. 1, aggregates of the silicon particles 13 among the graphite particles 11 of the silicon-containing anode material 1 obtained by the aforementioned conventional method are undesirably formed. The aggregates of the silicon particles 13 tend to cause a problem of cracking of the silicon-containing anode material 1 during intercalation of the lithium ions.

Therefore, there is still a need in the art for improving the service life of an anode material of a lithium ion battery.

### SUMMARY OF THE INVENTION

An object of the present invention is to provide a battery anode material that can overcome the aforesaid drawback associated with the prior art.

According to one aspect of the present invention, there is provided a stress-buffering silicon-containing composite particle for a battery anode material. The stress-buffering silicon-containing composite particle comprises: a stress-buffering particle having a Young's modulus greater than 100 GPa; a binder; and a silicon-containing shell surrounding and bonded to the stress-buffering particle through the binder. The silicon-containing shell has a plurality of silicon flakes that are randomly stacked and that are bonded to one another through the binder to form a porous structure.

According to another aspect of this invention, there is provided a method of preparing stress-buffering silicon-containing composite particles. The method comprises: (a) mixing a binder and a solvent to form a binder solution; (b) adding a plurality of silicon flakes into the binder solution, followed by stirring evenly to form a first mixture slurry; and (c) after the silicon flakes are uniformly dispersed in the first mixture slurry, adding a plurality of stress-buffering particles into the first mixture slurry, followed by stirring evenly so that the stress-buffering particles are uniformly dispersed in the first mixture slurry and the silicon flakes are bonded to the stress-buffering particles to form a second mixture slurry, wherein the second mixture slurry contains a plurality of stress-buffering silicon-containing composite particles, each of which has a silicon-containing shell surrounding and bonded to a respective one of the stress-buffering particles through the binder. The stress-buffering particles have a Young's modulus greater than 100 GPa.

### BRIEF DESCRIPTION OF THE DRAWINGS

In drawings which illustrate an embodiment of the invention,

FIG. 1 is a schematic view of a conventional silicon-containing anode material;

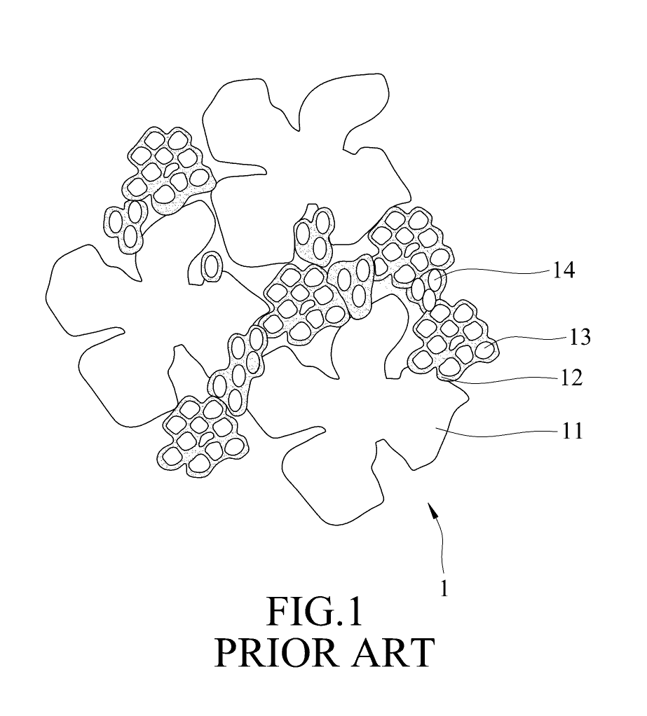

FIG. 2 is a schematic view of the first embodiment of a stress-buffering silicon-containing composite particle for a battery anode material according to the present invention;

FIG. 3 is a SEM diagram illustrating the configuration of silicon flakes employed in a stress-buffering silicon-containing composite particle of Example 1;

FIG. 4 is a SEM diagram illustrating the configuration of silicon flakes employed in a stress-buffering silicon-containing composite particle of Example 2;

FIG. 5 is a SEM diagram illustrating the surface morphology of an anode material of Example 1;

FIG. 6 is a SEM diagram illustrating the surface morphology of an anode material of Comparative Example 1;

FIG. 7 is a plot of specific capacity vs. potential, illustratingtheresultsofthecharge-dischargecycle test of a lithium battery of Example 1;

FIG. 8 is a plot of specific capacity vs. potential, illustratingtheresultsofthecharge-dischargecycle test of a lithium battery of Example 2;

FIG. 9 is a plot of specific capacity vs. potential, illustrating the results of the charge-discharge cycle test of a lithium battery of Comparative Example 1; and

FIG. 10 is aplot of the number of cycles vs. specific capacity, illustrating the results of the charge-discharge cycle test of the lithium battery of Example 1.

### DETAILED DESCRIPTION OF THE EMBODIMENT

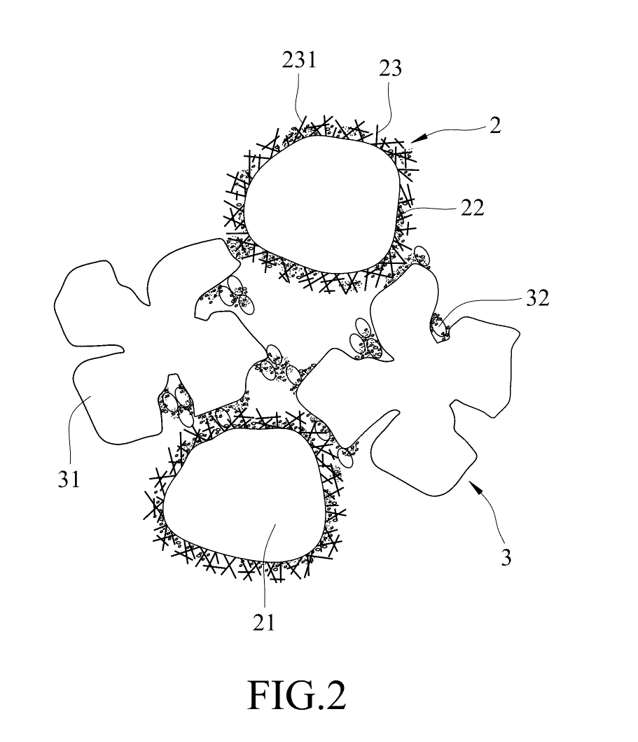

FIG. 2 illustrates the embodiment of a stress-buffering silicon-containing composite particle 2 for an anode material of a lithium ion battery according to the present invention. The stress-buffering silicon-containing composite particle 2 includes: a stress-buffering particle 21 having a Young's modulus greater than 100 GPa; a binder 22; and a silicon-containing shell 23 surrounding and bonded to the stress-buffering particle 21 through the binder 22. The silicon-containing shell 23 has a plurality of silicon flakes 231 that are randomly stacked and that are bonded to one another through the binder 22 to form a porous structure.

The porous structure thus formed on the stress-buffering particle 21 can provide a buffering effect for absorbing stress caused by volume expansion of the stress-buffering silicon-containing composite particle 2 during charging or intercalation of lithium ions thereon. In addition, the stress-buffering particle 21 has a Young's modulus greater than 100 GPa that can also provide a buffering effect for absorbing the stress. Hence, when the stress-buffering silicon-containing composite particle 2 is used as the anode material of the lithium ion battery, the aforesaid cracking caused by the volume expansion of the aforesaid conventional silicon-containing anode material during charging may be alleviated.

Preferably, the stress-buffering particle 21 is made from a material selected from the group consisting of silicon carbide (SiC), silicon nitride (Si₃N₄), titanium nitride (TiN), titanium carbide (TiC), tungstencarbide (WC),aluminumnitride (AlN),gallium, germanium, boron, tin, and indium. More preferably, the stress-buffering particle 21 is made from silicon carbide.

Preferably, the binder 22 is made from a material selected from the group consisting of polyolefin, fluorine-containing rubbers, non-fluorine-containing rubbers, cellulose derivatives, polysaccharide, water-soluble resins, and combinations thereof. More preferably, the binder 22 is made from a material selected from the group consisting of polyvinylidene chloride, polyvinylidene fluoride (PVDF), polyfluoro vinylidene, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene polymer (EPDM), sulfonated ethylene-propylene-diene polymer, styrene butadiene rubber (SBR), fluorine rubber, and combinations thereof. Some materials of the binder 22, e.g., styrene butadiene rubber (SRB), have hydrophilic groups and thus exhibit hydrophilic property. Some materials of the binder 22, e.g., polyvinylidene fluoride (PVDF), have lipophilic groups and thus exhibit lipophilic property. Most preferably, the material of the binder 22 is selected from the group consisting of styrene butadiene rubber (SRB), carboxymethyl cellulose, and the combination thereof.

Preferably, the silicon flakes 231 have a length and a thickness. The thickness of the silicon flakes 231 ranges from 20 to 300 nm. A ratio of the length to the thickness of the silicon flakes 231 ranges from 2:1 to 2000:1. More preferably, the thickness of the silicon flakes 231 ranges from 50 to 100 nm, and the ratio of the length to the thickness of the silicon flakes 231 ranges from 10:1 to 2000:1. The use of the silicon flakes 231 having a nano-scale thickness can considerably reduce the volume expansion during the charging.

Preferably, based on the total weight of the stress-buffering silicon-containing composite particle 2, the stress-buffering particle 21 is in an amount ranging from 5 to 90 wt %, the binder 22 is in an amount ranging from 0.5to20 wt %, and the silicon flakes 231 are in an amount ranging from 1 to 75 wt %. More preferably, based on the total weight of the stress-buffering silicon-containing composite particles 2, the stress-buffering particle 21 is in an amount ranges from 15 to 80 wt %, the binder 22 is in an amount ranges from 1 to 10 wt %, and the silicon flakes 231 are in an amount ranges from 10 to 70 wt %. The weight percentages of the aforesaid components of the stress-buffering silicon-containing composite particle 2 are determined by disposing the stress-buffering silicon-containing composite particle 2 in water to dissolve the binder 22 so as to separate the stress-buffering particle 21 and the silicon flakes 231 (the total weight (w) of the stress-buffering silicon-containing composite particle 2 and water being measured), centrifuging to respectively obtain the stress-buffering particle 21 and the silicon flakes 231, and determining the weights of the stress-buffering particle 21 and the silicon flakes 231. The weight of the binder 22 is obtained by subtracting the weights of the stress-buffering particle 21, the silicon flakes 231, and water from the total weight (w) of the stress-buffering silicon-containing composite particle 2 and water.

A plurality of the stress-buffering silicon-containing composite particles 2 may be mixed with a binder material and a carbonaceous material 3 for making the lithium battery anode material. Examples of the carbonaceous material 3 include, but are not limited to, soft carbons (low temperature calcinated or sintered carbon), hard carbons (pyrolytic carbon), amorphous carbon materials, graphite particles, conductive carbon powder, and combinations thereof. Preferably, as shown in FIG. 2, the carbonaceous material 3 includes graphite particles 31 and conductive carbon powder 32.

The method of preparing the stress-buffering silicon-containing composite particles 2 of the present invention comprises the steps of: (a) mixing a binder 22 and a solvent to form a binder solution; (b) adding a plurality of silicon flakes 231 into the binder solution, followed by stirring evenly to form a first mixture slurry; and (c) after the silicon flakes 231 are uniformly dispersed in the first mixture slurry, adding a plurality of stress-buffering particles 21 into the first mixture slurry, followed by stirring evenly so that the stress-buffering particles 21 are uniformly dispersed in the first mixture slurry and the silicon flakes 231 are bonded to the stress-buffering particles 21 to form a second mixture slurry, wherein the second mixture slurry contains a plurality of stress-buffering silicon-containing composite particles 2, each of which has a silicon-containing shell 23 surrounding and bonded to a respective one of the stress-buffering particles 21 through the binder 22. The stress-buffering particles 21 have a Young's modulus greater than 100 GPa.

The solvent is selected based on the type of the binder 22. For instance, when the binder 22 is hydrophilic, the solvent is preferably hydrophilic, and when the binder 22 is lipophilic, the solvent is preferably lipophilic. Preferably, the solvent is water or N-methyl pyrrolidone (NMP).

The merits of the embodiment of this invention will become apparent with reference to the following Examples and Comparative Examples.

### EXAMPLES 1 AND 2 AND COMPARATIVE EXAMPLE 1

### Preparation of Anode Materials for Lithium Ion Batteries

### EXAMPLE 1 (EX1)

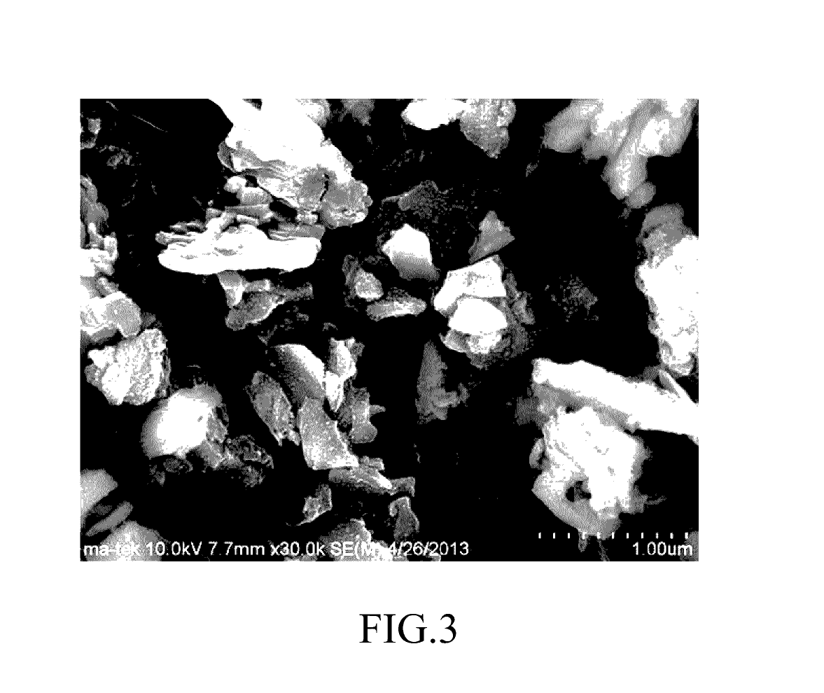

SBR (serving as the first binder) was dissolved in water to obtain a binder solution. Silicon flakes (cut from a silicon source using a wire saw, and having a thickness ranging from 100 to 300 nm, and a length ranging from 200 to 10,000 nm, FIG. 3 shows the SEM morphology of the silicon flakes) were added into the binder solution under stirring to forma first mixture slurry.

After the silicon flakes were uniformly dispersed in the first mixture slurry, silicon carbide particles (serving as the stress-buffering particles) were then added into the first mixture slurry, followed by stirring evenly so that the stress-buffering particles were uniformly dispersed in the first mixture slurry and the silicon flakes were bonded to the stress-buffering particles to form a second mixture slurry containing a plurality of stress-buffering silicon-containing composite particles.

Carboxymethyl cellulose (as a second binder) was dissolved in water under stirring at 1000 rpm for an hour to obtain a carboxymethyl cellulose solution. Conductive carbon powder was added into the carboxymethyl cellulose solution under stirring at 4000 rpm for 30 minutes. After the conductive carbon powder was uniformly dispersed in the carboxymethyl cellulose solution, the second mixture slurry was added into the carboxymethyl cellulose solution, followed by stirring at 4000 rpm for 30 minutes so that the stress-buffering silicon-containing composite particles were uniformly dispersed in the carboxymethyl cellulose solution. Graphite particles were then added (particle size: 18 μm) into the carboxymethyl cellulose solution under stirring at 4000 rpm for 30 minutes to obtain an anode material paste containing the stress-buffering silicon-containing composite particles.

A disc-shaped copper foil having an area of 1.33 cm² was prepared to serve as a substrate. The substrate was cleaned to remove oxide and organic pollutants thereon. The cleaned substrate was immersed in a mixture of acetone and ethanol and was subjected to sonication to remove oil and other pollutants on the surface thereof. 3 mg of the anode material paste was applied to the disc-shaped copper foil, followed by drying to remove the solvent (water) and hot pressing to form an anode electrode (i.e., negative electrode) of Example 1.

The composition of the anode material paste of Example 1 is shown in Table 1.

The anode electrode of Example 1 was used as a working electrode and was assembled with a lithium-based electrode (serving as a counter electrode), a polypropylene (PP) isolation membrane, and a LiPF₆ electrolyte in a conventional manner for preparing a CR2032 type lithium battery.

### EXAMPLE 2 (EX2)

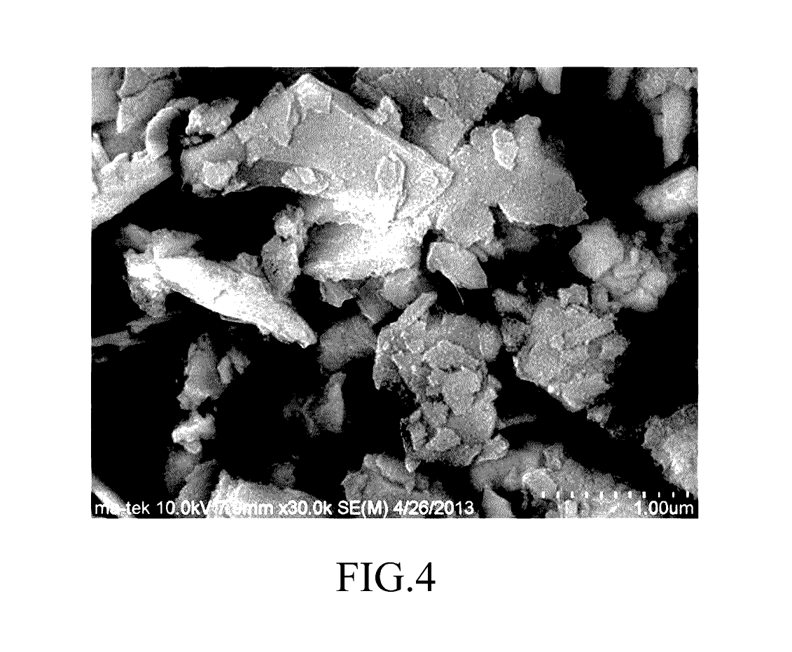

The procedures and conditions in preparing the anode material paste containing the stress-buffering silicon-containing composite particles, the anode electrode and the CR2032 type lithium battery of Example 2 were similar to those of Example 1, except for the thickness and the length of the silicon flakes used to form the stress-buffering silicon-containing composite particles. The silicon flakes employed in Example 2 have a thickness ranging from 50 to 100 nm, and a length ranging from 100 to 10,000 nm (FIG. 4 shows the SEM diagram of the silicon flakes of Example 2).

The composition of the anode material paste of Example 2 is shown in Table 1.

### COMPARATIVE EXAMPLES 1 (CE1)

SBR (serving as the first binder) was dissolved in water to obtain a binder solution.

Silicon carbide particles (serving as the stress-buffering particles and having a particle size of 12 μm and a Young's modulus of 450 GPa), graphite particles (having a particle size of 18 μm) and conductive carbon powder were added into the binder solution, followed by stirring to obtain a first mixture slurry. Silicon flakes (having a thickness ranging from 100 nm to 300 nm and a length ranging from 100 nm to 10000 nm) were added into the first mixture slurry, followed by stirring evenly so that the silicon flakes were uniformly dispersed in the first mixture slurry to obtain an anode material paste containing a plurality of silicon flakes.

A disc-shaped copper foil having an area of 1.33 cm² was prepared to serve as a substrate. The substrate was cleaned to remove oxide and organic pollutants on the surface thereof. The substrate was immersed in a mixture of acetone and ethanol, and was subjected to sonication to remove oil and other pollutants on the surface thereof. 3 mg of the anode material paste was applied to the disc-shaped copper foil, followed by drying to remove the solvent (water) and hot pressing to form an anode electrode of Comparative Example 1. The procedures and conditions in preparing the anode electrode and the CR2032 type lithium battery of Comparative Example 1 were similar to those of Example 1.

The composition of the anode material paste of Comparative Example 1 is shown in Table 1.

TABLE 1

| | | | EX1 | EX2 | CE1 |
|---|---|---|---|---|---|
| Stress-buffering | Stress-buffering | type | SiC | SiC | — |
| silicon-containing | particle | amount (wt %) | 30 | 30 | — |
| composite particle | Silicon | Thickness of | 100-300 | 50-100 | — |
| (based on the total | containing shell | silicon | | | |
| weight of the | | flakes (nm) | | | |
| composite | | length of | 200-10000 | 100-10000 | — |
| particle) | | silicon flakes | | | |
| | | (nm) | | | |
| | | Amount (wt %) | 67.5 | 67.5 | — |
| | First binder | type | SBR | SBR | — |
| | | amount (wt %) | 2.5 | 2.5 | — |

| | | | | |
|---|---|---|---|---|
| Anode material | Stress-buffering | 7.5 | 7.5 | — |
| containing the | silicon-containing composite | | | |
| stress-buffering | particle | | | |
| silicon-containing | Stress-buffering particle | — | — | 2.5 |
| composite particle | Conductive carbon powder | 15 | 15 | 15 |
| (based on the total | Graphite particle | 72.5 | 72.5 | 72.5 |
| weight of the Anode | Second binder | 5 | 5 | 5 |
| material) | Silicon flakes | — | — | 5 |
| (wt %) | | | | |

“—” means none or not available.

### <Performance Test>

### Charge-Discharge Cycle Test

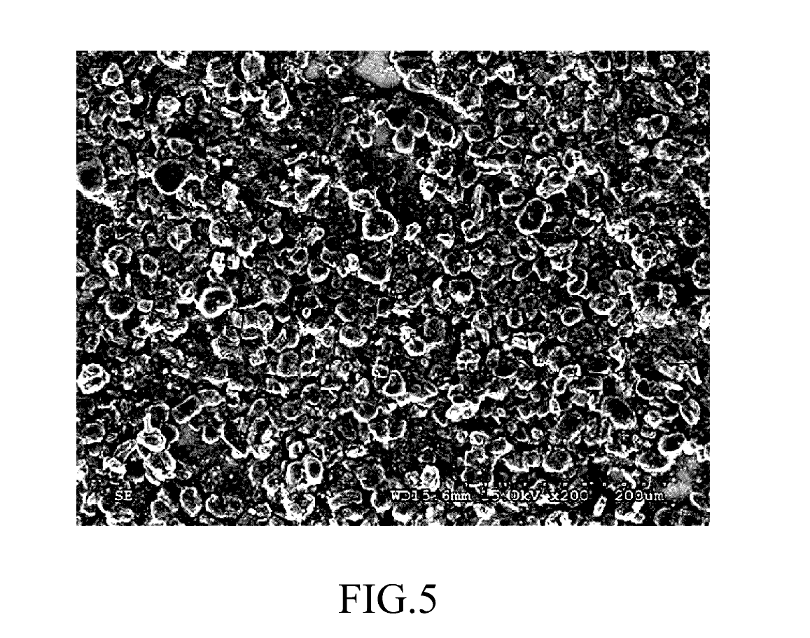

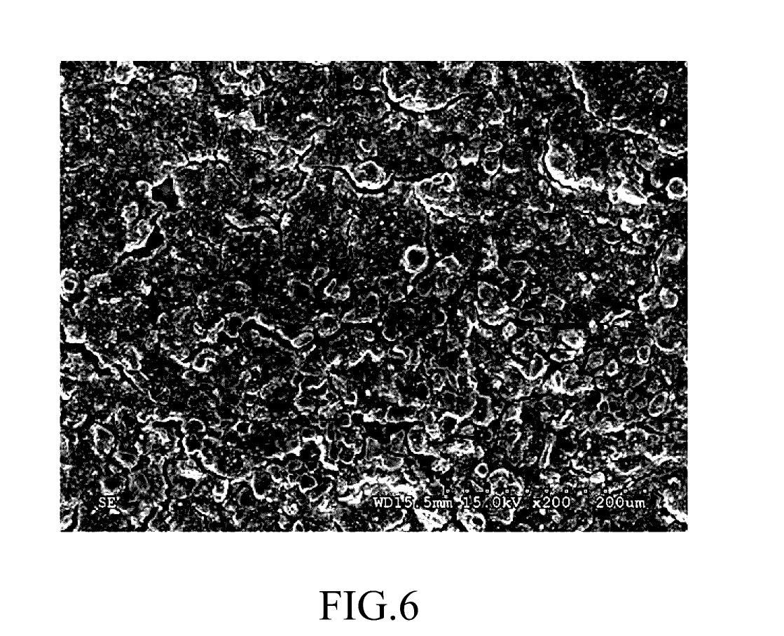

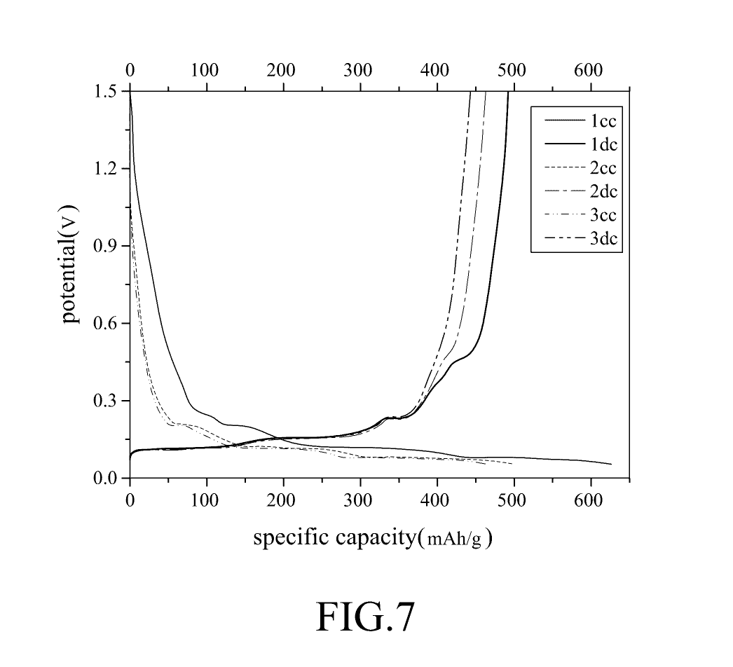

The lithium battery of each of Examples 1 and 2 and Comparative example 1 was subjected to charge-discharge cycle test that was operated within a voltage cycle between 0V and 1.5V at a 0.1C (Coulomb) rate under 25° C. FIG. 5 is an SEM diagram showing the surface morphology of the anode material of the lithium battery of Example 1 after a 250^{th} cycle of the charge-discharge operation. FIG. 6 is an SEM diagram showing the surface morphology of the anode material of the lithium battery of Comparative Example 1 after a 3^{rd} cycle of the charge-discharge operation. The results show that the anode material of Example 1 is free of cracks after the 250^{th} cycle, while the anode material of Comparative Example 1 is formed with several cracks. FIGS. 7 to 9 show the capacity characteristics of the charge-discharge test for Examples 1 and 2 and Comparative Example 1, respectively.

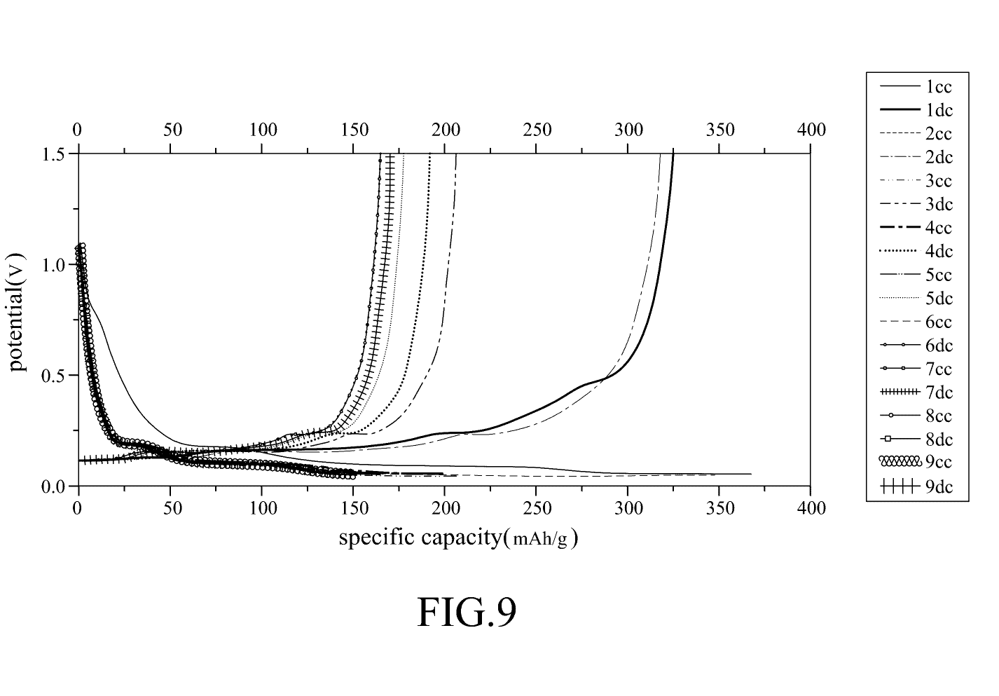

In FIGS. 7 to 9, the term “cc” represents charge, and the term “dc” represents discharge. As shown in FIG. 9, the specific capacity of Comparative Example 1 drops from about 370 mAh/g at the first cycle to about 220 mAh/g at the third cycle and further to about 150 mAh/g at the ninth cycle for charging operation, and drops from about 325 mAh/g at the first cycle to about 210 mAh/g at the third cycle and further to about 170 mAh/g at the ninth cycle for discharging operation.

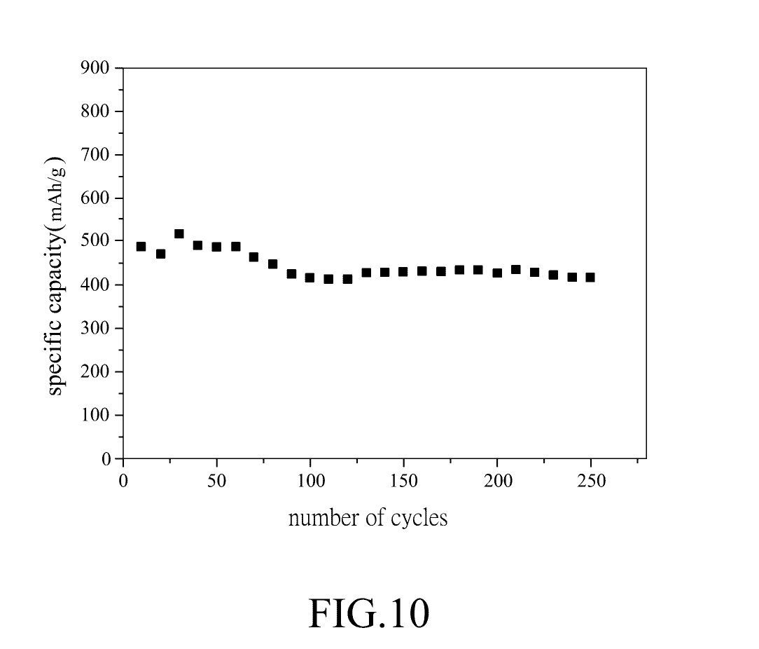

As shown in FIG. 7, in combination with FIG. 10, the specific capacity of Example 1 drops from about 620 mAh/g at the first cycle to about 450 mAh/g at the third cycle and further to about 400 mAh/g at the 250^{th} cycle (see FIG. 10) for charging operation, and drops from about 500 mAh/g at the first cycle to about 450 mAh/g at the third cycle and further to about 400 mAh/g at the 250^{th} cycle (see FIG. 10) for discharging operation.

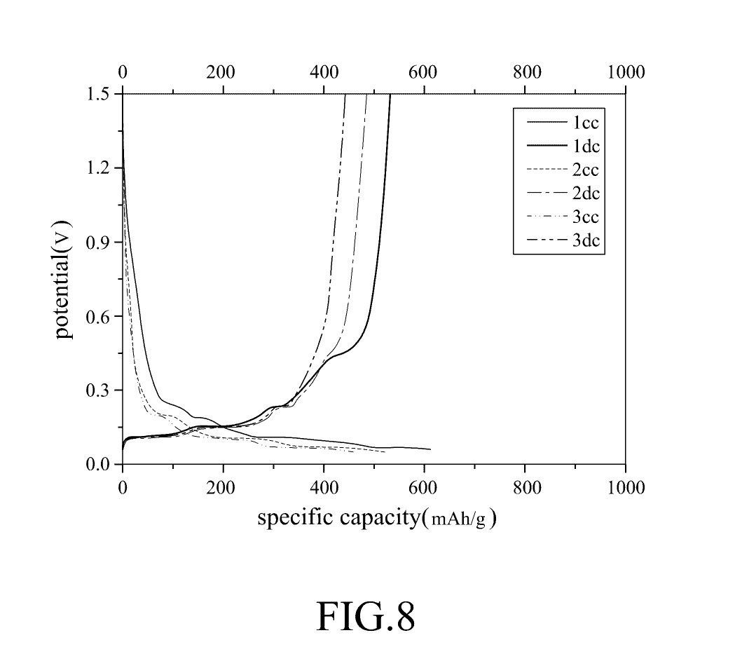

As shown in FIG. 8, the specific capacity of Example 2 drops from about 610 mAh/g at the first cycle to about 520 mAh/g at the second cycle and further to about 460 mAh/g at the third cycle for charging operation, and drops from about 530 mAh/g at the first cycle to about 490 mAh/g at the second cycle and further to about 440 mAh/g at the third cycle for discharging operation.

In conclusion, with the inclusion of the stress-buffering silicon-containing composite particle in the lithium battery anode material of this invention, the aforesaid drawback associated with the prior art can be alleviated.

With the invention thus explained, it is apparent that various modifications and variations can be made without departing from the spirit of the present invention. It is therefore intended that the invention be limited only as recited in the appended claims.

What is claimed is:

1. A stress-buffering silicon-containing composite particle for a battery anode material, comprising:
a stress-buffering particle having a Young's modulus greater than 100 GPa;
a binder; and
a silicon-containing shell surrounding and bonded to said stress-buffering particle through said binder;
wherein said silicon-containing shell has a plurality of silicon flakes that are randomly stacked and that are bonded to one another through said binder to form a porous structure.

2. The stress-buffering silicon-containing composite particle as claimed in claim 1, wherein said stress-buffering particle is made from a material selected from the group consisting of silicon carbide, silicon nitride, titanium nitride, titanium carbide, tungsten carbide, aluminum nitride, gallium, germanium, boron, tin, indium, and combinations thereof.

3. The stress-buffering silicon-containing composite particle as claimed in claim 1, wherein said binder is made from a material selected from the group consisting of polyolefin, fluorine-containing rubbers, non-fluorine-containing rubbers, cellulose derivatives, polysaccharide, water-soluble resins, and combinations thereof.

4. The stress-buffering silicon-containing composite particle as claimed in claim 3, wherein said binder is made from a material selected from the group consisting of polyvinylidene chloride, polyvinylidene fluoride, polyfluoro vinylidene, polyvinyl alcohol, carboxymethyl cellulose, starch, hydroxypropyl cellulose, regenerated cellulose, polyvinyl pyrrolidone, tetrafluoroethylene, polyethylene, polypropylene, ethylene-propylene-diene polymer, sulfonated ethylene-propylene-diene polymer, styrene butadiene rubber, fluorine rubber, and combinations thereof.

5. The stress-buffering silicon-containing composite particle as claimed in claim 4, wherein said binder is made from a material selected from the group consisting of styrene butadiene rubber, carboxymethyl cellulose, and the combination thereof.

6. The stress-buffering silicon-containing composite particle as claimed in claim 1, wherein said silicon flakes have a length and a thickness, the thickness of said silicon flakes ranging from 20 to 300 nm, a ratio of the length to the thickness of said silicon flakes ranging from 2:1 to 2000:1.

7. The stress-buffering silicon-containing composite particle as claimed in claim 1, wherein said stress-buffering particles are in an amount ranging from 5 to 90 wt %, said binder is in an amount ranging from 0.5 to 20 wt %, and said silicon flakes are in an amount ranging from 1 to 75 wt % based on the total weight of the stress-buffering silicon-containing composite particles.

8. A method of preparing stress-buffering silicon-containing composite particles, comprising:
(a) mixing a binder and a solvent to form a binder solution;
(b) adding a plurality of silicon flakes into the binder solution, followed by stirring evenly to form a first mixture slurry; and
(c) after the silicon flakes are uniformly dispersed in the first mixture slurry, adding a plurality of stress-buffering particles into the first mixture slurry, followed by stirring evenly so that the stress-buffering particles are uniformly dispersed in the first mixture slurry and the silicon flakes are bonded to the stress-buffering particles to form a second mixture slurry, wherein the second mixture slurry contains a plurality of stress-buffering silicon-containing composite particles, each of which has a silicon-containing shell surrounding and bonded to a respective one of the stress-buffering particles through the binder;
wherein the stress-buffering particles have a Young's modulus greater than 100 GPa.

9. The method of claim 8, wherein the solvent is water or N-methyl pyrrolidone.

10. The method of claim 8, wherein the binder is made from a material selected from the group consisting of polyvinylidene chloride, polyvinylidene fluoride, polyfluoro vinylidene, polyvinyl alcohol, carboxymethyl cellulose, starch, hydroxypropyl cellulose, regenerated cellulose, polyvinyl pyrrolidone, tetrafluoroethylene, polyethylene, polypropylene, ethylene-propylene-diene polymer, sulfonated ethylene-propylene-diene polymer, styrene butadiene rubber, fluorine rubber, and combinations thereof.

11. The method of claim 8, wherein the stress-buffering particles are made from a material selected from the group consisting of silicon carbide, silicon nitride, titanium nitride, titanium carbide, tungsten carbide, aluminum nitride, gallium, germanium, boron, tin, indium, and combinations thereof.

12. The method of claim 8, wherein the silicon flakes have a length and a thickness, the thickness of the silicon flakes ranging from 20 to 300 nm, and the ratio of the length to the thickness of the silicon flakes ranging from 2:1 to 2000:1.
